(19) United States
(12) Patent Application Publication
(10) Pub. No.: US 2009/0256084 A1
(43) Pub. Date: Oct. 15, 2009

(54) Process and apparatus for retrieving information projected image-wise on a photo-stimulable phosphor imaging substrate

(76) Inventors: EDGAR ALZNER, Garden City, NY (US); Yehuda Rosenstock, Freeport, NY (US)

Correspondence Address: CLIFFORD G. FRAYNE, 136 DRUM POINT RD, SUITE 7A, BRICK, NJ, 08723, US

(21) Appl. No.: 12/454,814

(22) Filed: May 22, 2009

Related U.S. Application Data
(63) Continuation-in-part of application No. 10/933,648, filed on Sep. 3, 2004, now abandoned.
(60) Provisional application No. 60/500,764, filed on Sep. 5, 2003.

(51) Int. Cl. G01T 1/10

(52) U.S. Cl. 250/484.4

(57) ABSTRACT

These and other objects of the present invention are achieved by a process and apparatus for interrogating or scanning a photo-stimulable phosphor substrate containing projected image-wise information wherein a laser beam is directed towards a lens to produce a planar light beam directed onto the storage substrate as a focused light line to stimulate luminescent information detected by a linear sensor for collection and transmission to a computer assembly.

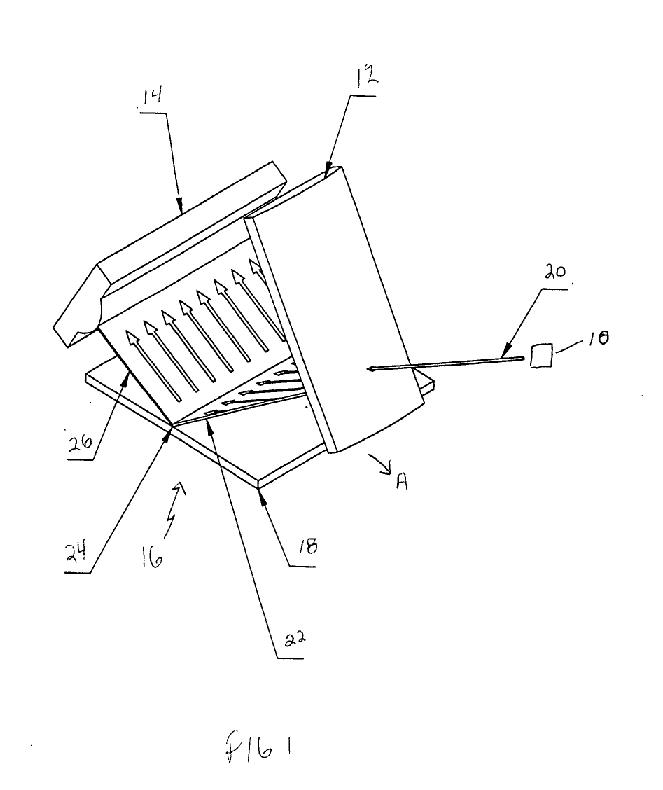

### RELATED APPLICATIONS

This is a continuation-in-part of application Ser. No. 10/933,648, filed Sep. 3, 2004, which application claimed the benefit of provisional application 60/500,764, filed Sep. 8, 2003.

### BACKGROUND OF THE INVENTION

1. Field of the Invention

This invention relates to radiographic imaging, and to a process and apparatus for digitally retrieving information projected onto a photo-stimulable phosphor imaging substrate, and more particularly to a compact scanner for scanning an imaging substrate with a single scan line as the imaging substrate is transported past the scan line.

2. Description of the Prior Art

Traditional x-ray imaging systems using silver-based films are being replaced by radiographic imaging systems using photo-stimulable phosphor imaging substrates or films eliminating the need for physical storage of the resulting imaged film since digital retrieval of the image information includes input and computer storage permitting viewing of such information on a viewer, such as CRT tube assembly. Additionally, such computer stored image information permits facile electronic transmission to any preselect location obviating physical transfer of the thus formed image as developed on the imaging film.

In U.S. Pat. No. 5,874,744 to Goodman, et al., assigned to the same assignee as the present invention herein incorporated by reference, there is disclosed a process and apparatus for processing radiographic information from an anisotropic storage phosphor screen including an opto-electro-mechanical assembly to achieve raster scan of an interrogating beam and including detector and computer assembly.

The prior art is replete with a plethora of radiographic imaging information assemblies for reading projected image-wise information from a photo-stimulable phosphor sheet, film or substrate, e.g. see U.S. Pat. No. 6,624,457 to Kohada wherein excitation light emits photostimulated luminescent light from the stored energy of the projected image-wise information film. In such disclosure, the plate, film, sheet or substrate is disposed on a horizontal support surface and screened by an excitation scanning assembly including a laser beam. See also U.S. Pat. No. 4,676,582 to Kato, et al.

In U.S. Pat. No. 6,599,004 to Thoms, there is disclosed a device for reading flexible storage films wherein the flexible storage film having image-wise projected information is positioned on a cylindrically-shaped surface and is caused to be linearly moved there over while being interrogated or scanned via a slot by a light beam generated in a helical line in a continuous manner from a point disposed at the axis of the cylindrically-shaped surface.

There are a plethora of disclosures relating to retrieving information from a cylindrically disposed image-wise containing storable phosphor film or substance, e.g. U.S. Pat. No. 4,302,671 to Kato, el al. All such disclosures use a stimulating light beam as an element of an opto-mechanical assembly to interrogate and scan an image-wise storable phosphoric film. Such opto-mechanical assemblies must be accurately designed to reliably provide useful information, and as appreciated by those skilled in the art, must be precisely manufactured and calibrated to produce useful results given the micro-scanning requirements. Consequently, such opto-mechanical assemblies are costly and require excessive spacial designs.

As used herein, the term “storage substrate” is a film plate or sheet indicating photo-stimulable phosphors and is capable of being imaged with ionizing radiation or x-rays which after imaging may be interrogated or scanned with a source of light energy to produce photostimulated luminescence information capable of being digitally read and stored.

The present invention relates to a single plate scanner designed for high speed scanning of a photo-stimulable phosphor imaging plate with a reduced number of moving parts. The scanner is designed about a cylindrical lens that produces a focused straight line from an imported singular circular laser input. The photo-stimulable phosphor imaging plate being scanned is transported past the focused straight line in the focal plane and the emitted light is collected by a linear CCD element (charged coupled device). The photo-stimulable phosphor imaging plate is propelled by rollers or a belt system, and in the embodiment, a cylindrical lens is used to convert the circular laser point beam to a line drawn perpendicular to the photo-stimulable phosphor plate transport direction. The energy that is released from the plate due to the laser excitation and interrogation is collected by the linear CCD unit placed above or near the plate such that a full scan line can be collected at high speed as the plate moves under the laser line. The data collected by the linear CCD is then fed to an A/D unit that converts the analog data to numerical information. The collected numerical pixel information is then stored in an image memory file.

The single plate scanner system has several advantages over conventional scanning techniques in that no mechanical or laser deflection systems are required, such as mirrors, prisms, or polygons. The data is collected at high speed due to the illumination and capture of an entire scan line. The device can be manufactured at low cost and can be sized to accommodate the desired size of photo-stimulable phosphor imaging plates.

### OBJECTS OF THE INVENTION

An object of the present invention is to provide an improved process and apparatus for interrogating or scanning a photo-stimulable phosphor substrate.

Another object of the present invention is to provide an improved process and apparatus for interrogating or scanning a photo-stimulable phosphor substrate of improved speed and resolution.

Yet another object of the present invention is to provide an improved process and apparatus for interrogating or scanning a photo-stimulable phosphor substrate obviating costly and complex opto-mechanical assemblies.

A still further object of the present invention is to provide an improved process and apparatus for interrogating or scanning a photo-stimulable phosphor substrate of reduced size requirements.

A still further object of the present invention is to provide for an improved process and apparatus for interrogating or scanning a photo-stimulable phosphor imaging plate wherein a single circular laser beam is converted into a focused straight line beam for interrogation of a full scan line of the phosphor substrate, the energy released due to the laser excitation collected by a linear CCD unit at higher speed than normally possible.

A still further object of the present invention is to provide for a improved process and apparatus for interrogating or scanning a photo-stimulable phosphor imaging plate in which the photo-stimulable phosphor imaging plate is transported perpendicularly past the focused straight line for interrogation and scanning.

### SUMMARY OF THE INVENTION

These and other objects of the present invention are achieved by a process and apparatus for interrogating or scanning a photo-stimulable phosphor substrate containing projected image-wise information wherein a single laser beam is directed towards a lens to produce a planar light beam directed onto the storage substrate as a focused single light line to stimulate luminescent information detected by a linear sensor for collection and transmission to a computer assembly as the phosphor substrate passes past the single planar light beam.

### BRIEF DESCRIPTION OF THE DRAWINGS

Further objects and advantages of the present invention will become more readily apparent by reference to the following detailed description thereof when taken with the accompanying drawing wherein like numerals designate like parts throughout and wherein the Figure is a somewhat schematic perspective view of the process and apparatus of the present invention.

### DETAILED DESCRIPTION OF THE PRESENT INVENTION

Referring now to the drawing, there is illustrated the principle elements of the process and apparatus of the present invention comprised of a source of laser light source 10, a cylindrical lens 12, a linear light detector 14 and a horizontal and a transport assembly, generally indicated as 16 for positioning a photo-stimulable phosphor substrate 18 having a projected image formed thereon as more fully hereinafter described. It is understood to one skilled in the art that the elements are positioned within a suitable housing assembly (not shown) having a slot for inserting a storage substrate and an appropriate exit slot for withdrawing the scanned storage substrate. The transport assembly 16 may include roller and belt assemblies, such as disclosed in the aforementioned U.S. Patent to Thoms, however configured in horizontal array.

The laser light source 10 is disposed to direct a laser beam 20 to the cylindrical lens 14 dimensioned to produce a planar light beam 22 (indicated by the arrows) for projection as a focused light line 24 on the photo-stimulable substrate 18 being processed. The light line 24 is caused to be projected in a plane parallelledly disposed to the plane of the photo-stimulable phosphor substrate 18 being moved on the transport assembly 16. Intensity energy level of the laser beam 10 is at a level adequate to produce a light line 22 after passage through the lens 12 at an intensity level sufficient to stimulate the light energy stored on the photo-stimulable phosphor substrate 18. In this respect, such intensity level is significantly greater than an intensity level of a light beam required for point by point scanning as herein above referenced. Additionally the cylindrical lens 14 is preferably dimensioned to form a light line 22 of like height to the diameter of the laser beam 20, although such dimensioned relationship may be varied as a function of desired resolution information to be retrieved, as more fully hereinafter discussed.

Photo-stimulable luminescent light generated at the contact line 24 is detected by the light detector 14, as illustrated by arrows on the plane 26 including for example CCD elements, and processed, such as disclosed in the aforementioned U.S. Patent to Goodman, et al. It will be understood that positioning of the light detector 14 in the housing is for most efficacious detections and collection of the photo-stimulable luminescent light, as understood by one skilled in the art not in reflection as suggested by the plane 26 and accompanying arrows, in order to facilitate an understanding of the invention.

In operation, a photo-stimulable phosphor substrate 18 having a projected image thereon for scanning is positioned proximate the entry slot as hereinabove discussed and sensed to cause the transport assemblies to move the substrate along a horizontal plane into the housing assembly. The storage substrate is moved in a direction indicated by the arrows “A” in essentially perpendicular relationship to the plane of the planar light beam 22 and the resulting contact light line 24 to effect photo-stimulable luminescence, as herein above discussed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed is:

1. A process for scanning a photo-stimulable phosphor substrate having an image projected thereon with a light capable of producing readable photo-stimulable luminescent light from stored energy of the projected image-wise information which is detected, collected and stored in a computer assembly which consists of:
directing a single laser beam to and through a lens to generate a planar light line to be focused as a light line on said photo-stimulable phosphor substrate to generate a scan line of said readable luminescent light;
transporting said substrate through said planar light line to excite and interrogate said projected image-wise information; and
collecting said generated luminescent light by a light detector CCD and storing said image in computer memory.

2. The process for scanning a photo-stimulable phosphor substrate as defined in claim 1 wherein intensity of said laser beam is adjusted to compensate for energy losses during passage through said lens to provide an energy level of said focused light line sufficient to excite stored energy of said projected image to a level to necessary produce said luminescent light.

3. The process for scanning a photo-stimulable phosphor substrate in accordance with claim 1 wherein said focused plane light line is in a plane parallelledly disposed to a plane of said transported substrate.

4. The process for scanning a photo-stimulable phosphor substrate in accordance with claim 1 wherein dimensional height of said focused light line is of like dimension as said laser beam.

5. An apparatus for scanning a photo-stimulable phosphor substrate having an image projected thereon with a light source capable of stimulating photo-stimulable luminescent light from stored energy of the projected image-wise information which is detected, collected and stored on a computer assembly, which consists of:
a single laser beam;
a lens means on which said laser beam is directed for forming a planar light beam, said planar light beam directed to said photo-stimulable phosphor substrate to form a scan line thereon to generate luminescent light;
a transport means for moving said photo-stimulable phosphor substrate in planar relationship through said apparatus and passed said scan line for interrogation; and
collecting said generated luminescent light by a light detector CCD and storing said image in computer memory.

6. The apparatus for scanning a photo-stimulable phosphor substrate as defined in claim 5 wherein said lens means generates said light line of like dimension to said laser beam.

7. The apparatus for scanning a photo-stimulable phosphor substrate as defined in claim 5 wherein said lens means generates said light line at least of like dimension to a width of said photo-stimulable phosphor substrate being processed.

8. The apparatus for scanning a photo-stimulable phosphor substrate as defined in claim 5 wherein said transport means moves said photo-stimulable phosphor substrate in parallelledly relationship to said light line through said apparatus.
